(19) United States
(12) Patent Application Publication
(10) Pub. No.: US 2025/0266748 A1
(43) Pub. Date: Aug. 21, 2025

(54) LOAD POWER BASED DC-DC CONVERTER

(71) Applicant: KOREA ELECTRONICS TECHNOLOGY INSTITUTE, Seongnam-si (KR)

(72) Inventors: Jun Hyuk CHOI, Bucheon-si (KR); Jin Hong KIM, Suwon-si (KR); Joon Sung PARK, Seoul (KR); Byong Jo HYON, Anyang-si (KR); Yongsu NOH, Seoul (KR); Sang Min PARK, Bucheon-si (KR); Dongmyoung JOO, Seoul (KR); Daeyeon HWANG, Incheon (KR); Poo Reum JANG, Incheon (KR); Hyoung-Kyu YANG, Seoul (KR)

(21) Appl. No.: 19/001,950

(22) Filed: Dec. 26, 2024

(30) Foreign Application Priority Data
Feb. 16, 2024 (KR) 10-2024-0022651

(51) Int. Cl. H02M 1/00; H02M 3/00; H02M 3/158

(52) U.S. Cl. CPC H02M 1/0019; H02M 1/0058; H02M 3/01; H02M 3/158

(57) ABSTRACT

Proposed is a load power based DC-DC converter. The load power based DC-DC converter may include an input circuit that is connected to an input terminal and includes a main switch. The converter may also include a resonant circuit that is connected to the input circuit and includes an auxiliary switch for zero-voltage switching the main switch. The converter may further include an output circuit that is connected to the resonant circuit and outputs a voltage to an output terminal. The converter may further include a controller that controls the main switch and the auxiliary switch, in which the controller calculates a load power, which is power output through the output terminal, and controls the auxiliary switch so that on duty of the auxiliary switch increases or decreases based on the load power.

### CROSS-REFERENCE TO RELATED APPLICATIONS

This application claims priority under 35 U.S.C. § 119 to Korean Patent Application No. 10-2024-0022651, filed on Feb. 16, 2024, in the Korean Intellectual Property Office, the disclosure of which is incorporated herein by reference in its entirety.

### BACKGROUND

### Technical Field

The following disclosure relates to a load power based DC-DC converter, and more particularly, to a load power based DC-DC converter capable of minimizing energy loss occurring in a power conversion process by controlling an auxiliary switch according to load power, which is power output through an output terminal, and enabling soft switching of a main switch.

### Description of Related Technology

Recently, a zero voltage transition-partial resonant converter (ZVT-PRC) has been widely used as a power conversion device mounted on aircraft and electric vehicles. A zero voltage transition-partial resonant converter converts power using soft switching, so it may have low energy loss and high power transfer efficiency.

### SUMMARY

One aspect is a load power based DC-DC converter for calculating load power, which is power output through an output terminal, and minimizing energy loss of the converter by controlling a duty of an auxiliary switch according to the load power.

Another aspect is a load power based DC-DC converter that includes: an input circuit that is connected to an input terminal and includes a main switch; a resonant circuit that is connected to the input circuit and includes an auxiliary switch for zero-voltage switching the main switch; an output circuit that is connected to the resonant circuit and outputs a voltage to an output terminal; and a controller that controls the main switch and the auxiliary switch, in which the controller calculates a load power, which is power output through the output terminal, and controls the auxiliary switch so that on duty of the auxiliary switch increases or decreases based on the load power.

The resonant circuit may include: a resonant capacitor that is connected in parallel with the main switch; a resonant inductor that has one terminal connected to the resonant capacitor; and an auxiliary diode that has an anode connected to the other terminal of the resonant inductor and a cathode connected to the output circuit, and one terminal of the auxiliary switch may be connected to the other terminal of the resonant inductor, and the other terminal of the auxiliary switch may be connected to the other terminal of the resonant capacitor.

The controller may control the auxiliary switch so that the on duty of the auxiliary switch increases when the load power increases and control the auxiliary switch so that the on duty of the auxiliary switch decreases when the load power decreases.

The controller may include a load power based lookup table which is a lookup table in which the on duty of the auxiliary switch is stored for each predetermined margin of the load power, and the controller may control the auxiliary switch with the on duty of the auxiliary switch stored in the load-based lookup table as the load power varies.

The output circuit may further include: a main diode that has an anode connected to the other terminal of the resonant inductor and a cathode connected to the cathode of the auxiliary diode; and a DC capacitor that has one terminal connected to the cathode of the main diode and the other terminal connected to a negative electrode of the output terminal.

When the load power is P_{Load}, a voltage of the output terminal is Vₒᵤₜ, and a current of the output terminal is Iₒᵤₜ, the load power may be calculated according to the following Equation 1.

$${P}_{Load} = {V}_{out} \cdot {I}_{out} \qquad Equation 1$$

The input circuit may include a first inductor having one terminal connected to a positive electrode of the input terminal and the other terminal connected to one terminal of the main switch, and the other terminal of the main switch may be connected to a negative electrode of the input terminal.

### BRIEF DESCRIPTION OF THE DRAWINGS

FIG. 1 is a circuit diagram of a DC-DC converter.

FIG. 2 is a graph of voltage of components included in the DC-DC converter of FIG. 1.

FIG. 3 is a circuit diagram of a load power based DC-DC converter according to an embodiment of the present disclosure.

FIG. 4 is a graph showing an embodiment of an on duty of an auxiliary switch according to a lower power fluctuation.

### DETAILED DESCRIPTION

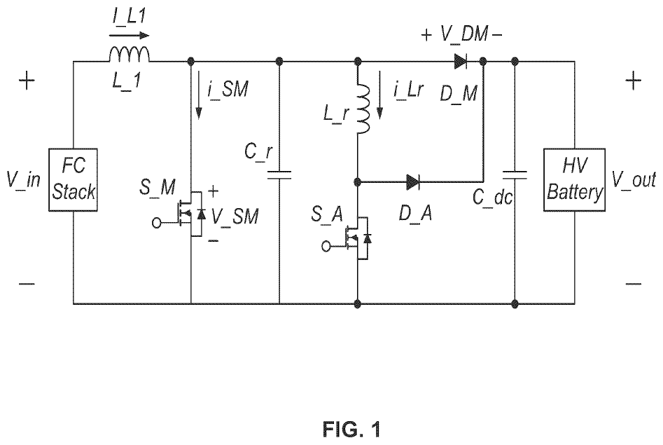

FIG. 1 illustrates a DC-DC converter. As illustrated in FIG. 1, the DC-DC converter boosts an input voltage and transmits the boosted input voltage to an output terminal, and includes a main switch S_{M} and an auxiliary switch S_{A}, respectively. Here, the main switch and the auxiliary switch are power semiconductors.

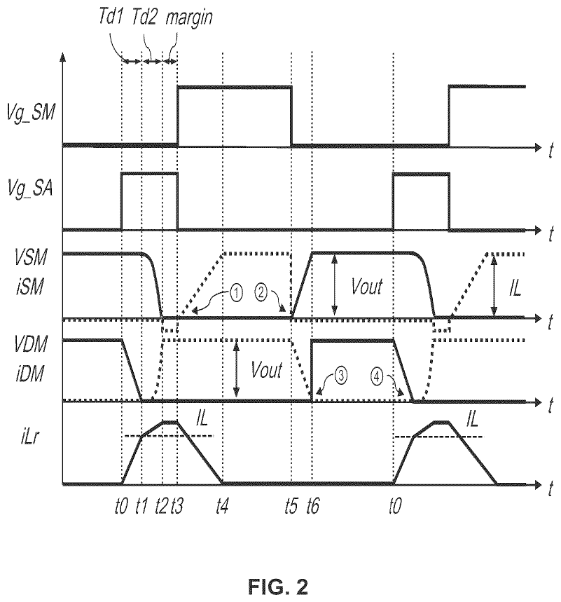

FIG. 2 is a graph of voltages of components included in the DC-DC converter of FIG. 1.

Referring to FIG. 2, before a turn-on control signal is applied to a gate V_{g_SM} of the main switch for soft switching, a voltage V_{SM} across the main switch should be in a zero voltage state. The auxiliary switch is turned on in T_{d1}, T_{d2}, and a freewheeling margin of FIG. 2 to help the voltage v_{SM} across the main switch after T_{d2} be in the zero voltage state. Thereafter, the main switch is turned on (point \textcircled{1} in FIG. 2) and turned off (point \textcircled{2} in FIG. 2) to perform a soft switching operation. In addition, the main diode is also subjected to zero voltage switching at points \textcircled{3} and \textcircled{4} in FIG. 2 to perform a soft switching operation. Here, when the voltage across the main switch reaches the zero voltage state, there is a freewheeling margin in which a freewheeling current flows in a resonant circuit. The freewheeling margin should be minimized so that the energy loss occurring in the converter decreases. Therefore, the auxiliary switch should be turned off quickly after reaching the zero voltage state and leaving a predetermined freewheeling margin.

In this case, a duty of the auxiliary switch is as follows.

$${T}_{SA} = {T}_{d 1} + {T}_{d 2} + margin$$

Referring to FIG. 2, in a T_{d1} margin, the auxiliary switch is turned on, which means the margin where the resonant current i_{Lr} increases, and in the T_{d2} margin, the DC-DC converter of FIG. 1 resonates for ¼ of a resonant cycle, and in a freewheeling margin, a freewheeling current flows through a body diode of the main switch, so the main switch may be turned on and controlled in the freewheeling margin to implement soft switching.

Here, T_{d1} and T_{d2} may be calculated as follows.

$${T}_{d 1} + {T}_{d 2} = ( {I}_{L} \cdot {L}_{r} ) / {V}_{out} + {T}_{r} / 4$$

Referring to the above Equation, when an output voltage Vₒᵤₜ is constant, the duty of the auxiliary switch varies depending on I_{L}, which is the current flowing in a first inductor. When the load increases, Iₒᵤₜ should increase and thus I_{L} increases, so the on duty of the auxiliary switch should increase. On the contrary, when the load decreases, Iₒᵤₜ should decrease and thus I_{L} should decrease, so the on duty of the auxiliary switch should decrease.

However, when a DC-DC converter is installed in an electric vehicle, etc., the load due to the operation of the electric vehicle is not constant and the load characteristics change rapidly, so there is a problem that it is difficult to change the duty of the auxiliary switch in real time in response to this.

In addition, when the duty of the auxiliary switch is controlled assuming the maximum load power, which is the case where the load characteristics are maximum because the load characteristics change rapidly, there is a problem that the energy loss of the DC-DC converter increases because the freewheeling margin increases.

The above-described objects, features, and advantages of the present disclosure will become more obvious from the following detailed description provided in relation to the accompanying drawings. The following specific structural or functional descriptions are only exemplified for the purpose of explaining the embodiments according to the concept of the present disclosure, and the embodiments according to the concept of the present disclosure may be implemented in various forms and should not be construed as limited to the embodiments described herein or in the application. Since embodiments of the concept of the present disclosure may be variously modified and may have several forms, specific embodiments will be illustrated in the accompanying drawings and will be described in detail in the present specification or application. However, it is to be understood that the present disclosure is not limited to specific embodiments, but includes all modifications, equivalents, and substitutions falling in the spirit and the scope of the present disclosure. Terms such as first, second, or the like, may be used to describe various components, but these components are not to be construed as being limited to these terms. The terms are used only to distinguish one component from another component. For example, a first component may be named a second component and the second component may also be named the first component, without departing from the scope of the present disclosure. It is to be understood that when one component is referred to as being “connected to” or “coupled to” another component, it may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween. Other expressions for describing the relationship between components, such as between and immediately between or adjacent to and directly adjacent to, etc., should be interpreted similarly. Terms used in the present specification are used only in order to describe specific embodiments rather than limiting the present disclosure. Singular forms include plural forms unless the context clearly indicates otherwise. It is to be understood that terms “include,” “have,” or the like, used in the present specification specify the presence of features, numerals, steps, operations, components, parts, or a combination thereof described in the present specification, but do not preclude the presence or addition of one or more other features, numerals, steps, operations, components, parts, or a combination thereof. Unless indicated otherwise, it is to be understood that all the terms used in the specification including technical and scientific terms have the same meaning as those that are generally understood by those who skilled in the art. Terms generally used and defined in a dictionary are to be interpreted as the same meanings with meanings within the context of the related art, and are not to be interpreted as ideal or excessively formal meanings unless clearly indicated in the present specification. Hereinafter, exemplary embodiments of the present disclosure will be described in detail with reference to the accompanying drawings. The same reference numerals in each drawing denote the same components.

Hereinafter, a load power based DC-DC converter 1 according to an embodiment of the present disclosure will be described in detail with reference to the attached drawings.

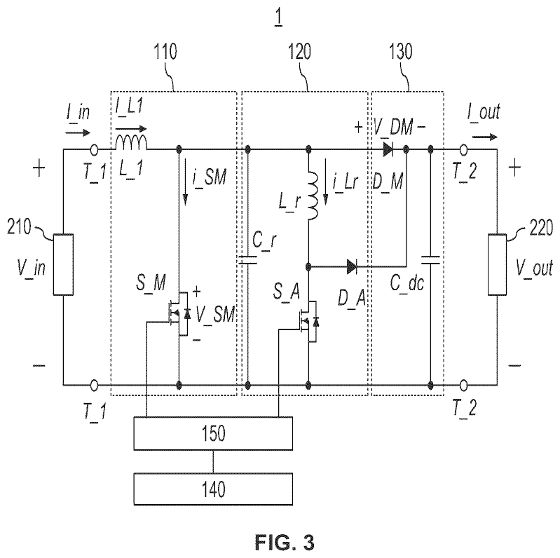

FIG. 3 is a circuit diagram of a load power based DC-DC converter 1 according to an embodiment of the present disclosure.

The load power based DC-DC converter 1 according to an embodiment of the present disclosure basically has characteristics of a boost converter. A voltage of a first power supply 210 applied to an input terminal T₁ through a first inductor L₁ and a main switch S_{M} of an input circuit 110 and a main diode D_{M} and a DC capacitor C_{dc} of an output circuit 130 is boosted and output to a second power supply 220 of an output terminal T₂. The load power based DC-DC converter 1 according to the present disclosure includes a resonant circuit 120 to assist soft switching of the main switch S_{M}.

That is, the low power based DC-DC converter 1 according to an embodiment of the present disclosure applies a partial resonant topology that enables zero voltage switching by generating resonance through the resonant circuit 120 for a certain period of time for soft switching of the main switch S_{M}.

Basically, the load power based DC-DC converter 1 according to an embodiment of the present disclosure operates on the same principle as the graph of an element voltage included in the DC-DC converter of FIG. 2, but a duty of a gate voltage v_{g_SA} of the auxiliary switch may have a different value from the duty illustrated in FIG. 2. However, even in this situation, a controller 140 of the lower power based DC-DC converter 1 according to an embodiment of the present disclosure controls an auxiliary switch S_{A} and the main switch S_{M} so that the main switch S_{M} is turned on after the auxiliary switch S_{A} is turned off.

The first power supply 210 and the second power supply 220 are energy sources or devices that may provide or receive power. For example, the first and second power supplies 210 and 220 may be DC power supplies such as a DC power supply, a power conversion device, and a battery including a fuel cell, a lithium ion battery, etc.

The load power based DC-DC converter 1 according to the present disclosure includes the input circuit 110, the resonant circuit 120, the output circuit 130, and the controller 140.

The input circuit 110 is connected to the input terminal T₁ and includes the main switch S_{M}. Specifically, the input circuit 110 is connected to the input terminal T₁ and includes the first inductor L₁ and the main switch S_{M}.

The input circuit 110 is connected to the first power supply 210 through the input terminal T₁. The first power supply 210 may be a device that outputs power having a DC voltage, and may be, for example, a secondary battery such as a fuel cell, a lithium ion battery, etc.

The first inductor L₁ has one terminal connected to a positive electrode of the input terminal T₁ and the other terminal connected to one terminal of the main switch S_{M}.

The main switch S_{M} has one terminal connected to the first inductor L₁ and the other terminal connected to a negative electrode of the input terminal T₁. The main switch S_{M} may include a body diode as a power semiconductor. The main switch may be composed of a power semiconductor element such as SiC, GaN, etc.

The resonant circuit 120 is connected to the input circuit 110 and includes an auxiliary switch S_{A} for performing zero-voltage switching of the main switch S_{M}. Specifically, the resonant circuit 120 includes a resonant capacitor Cᵣ, a resonant inductor Lᵣ, the auxiliary switch S_{A}, and an auxiliary diode D_{A}.

The resonant capacitor Cᵣ is connected in parallel with the main switch S_{M}. Specifically, one terminal of the resonant capacitor Cᵣ is connected to one terminal of the main switch S_{M}, and the other terminal is connected to the other terminal of the main switch S_{M}.

The resonant inductor Lᵣ has one terminal connected to the resonant capacitor Cᵣ, and the other terminal connected to one terminal of the auxiliary switch S_{A}.

A capacitance of the resonant capacitor Cᵣ and an inductance of the resonant inductor Lᵣ may have values that may cause resonance with each other.

The auxiliary switch S_{A} has one terminal connected to the other terminal of the resonant inductor Lᵣ, and the other terminal connected to the other terminal of the resonant capacitor Cᵣ. Like the main switch S_{M}, the auxiliary switch S_{A} may include the body diode as the power semiconductor.

The auxiliary diode D_{A} has an anode connected to the other terminal of the resonant inductor Lᵣ and a cathode connected to the output circuit 130. Specifically, the anode of the auxiliary diode D_{A} is connected between the other terminal of the resonant inductor Lᵣ and one terminal of the auxiliary switch S_{A}, and the cathode is connected to the cathode of the main diode D_{M}.

That is, depending on whether the auxiliary switch S_{A} is turned on or off, the resonant capacitor Cᵣ and the resonant inductor Lᵣ resonate to enable the main switch S_{M} of the input circuit 110 to be switched at zero voltage.

The output circuit 130 is connected to the resonant circuit 120 and outputs the converted voltage to the output terminal T₂. Specifically, the output circuit 130 includes the main diode D_{M} and the DC capacitor C_{dc}.

The main diode D_{M} has an anode connected to the other terminal of the resonant inductor Lᵣ and a cathode connected to the cathode of the auxiliary diode D_{A}.

The DC capacitor C_{dc} has one terminal connected to the cathode of the main diode D_{M} and the other terminal connected to the negative electrode of the output terminal T₂. Specifically, the DC capacitor C_{dc} serves to smooth the voltage output from the main diode D_{M}.

The controller 140 controls the main switch S_{M} and the auxiliary switch S_{A}. The controller 140 controls the main switch S and the auxiliary switch S_{A} so that the DC voltage input from the load power based DC-DC converter 1 to the input terminal T₁ is boosted and the boosted DC voltage is output to the output terminal T₂. In the power conversion process, the controller 140 controls the main switch S according to a duty control method of a general boost converter. At the same time, the controller 140 turns on the auxiliary switch S_{A} at T_{d1}, T_{d2}, and freewheeling margin of FIG. 2 so that the main switch S_{M} is switched to a zero voltage, thereby causing the resonant circuit 120 to resonate.

In the load power based DC-DC converter 1 according to an embodiment of the present disclosure, the controller 140 controls the auxiliary switch so that the on duty of the auxiliary switch increases or decreases based on the load power, which is the power output through the output terminal T2.

Specifically, the controller 140 may calculate the load power based on the current of the output terminal T₂. In the case of the second power supply 220 connected to the output terminal T₂, the load of the second power supply 220 may change rapidly depending on the operation of other devices connected to the second power supply 220. Therefore, the controller may sense the current of the output terminal T₂ to calculate the load power of the second power supply 220 and control the auxiliary switch S_{A} so that the on duty of the auxiliary switch S_{A} increases or decreases based on this.

The controller 140 may sense the current of the output terminal T₂ to obtain output current information. Specifically, the controller 140 may obtain the output current information including the current value of the output terminal T₂ from an output terminal current sensor that is provided separately from the load power based DC-DC converter 1 and senses the current of the output terminal T₂. In addition, the controller 140 may sense the voltage of the output terminal T₂ to obtain the output voltage information. Specifically, the controller 140 may obtain output voltage information including a voltage value of the output terminal T₂ from an output terminal voltage sensor that is provided separately from the load power based DC-DC converter 1 to sense the voltage of the output terminal T₂.

The controller 140 may calculate the load power based on the current of the output terminal T₂. Specifically, the load power is a value that uses the current of the output terminal T₂ as a variable, and when the current of the output terminal T₂ increases, the load power increases, and when the current of the output terminal T₂ decreases, the load power also decreases.

When the load power is P_{Load}, the voltage of the output terminal T₂ is Vₒᵤₜ, and the current of the output terminal T₂ is Iₒᵤₜ, the controller 140 calculates the load power according to the following Equation 1.

$${P}_{Load} = {V}_{out} \cdot {I}_{out} \qquad Equation 1$$

Specifically, the controller 140 calculates the load power by multiplying the current of the output terminal T₂ obtained from the output current information and the voltage of the output terminal T₂. Therefore, the load power has a unit of watt [W].

When the load power increases, the controller 140 controls the auxiliary switch S_{A} so that the on duty of the auxiliary switch S_{A} increases, and when the load power decreases, the controller controls the auxiliary switch S_{A} so that the on duty of the auxiliary switch S_{A} decreases. Specifically, in the case of the second power supply 220 connected to the output terminal, the voltage fluctuation according to the load fluctuation is small, so when the load connected to the second power supply 220 fluctuates, the voltage fluctuation range of the output terminal T₂ is small, but the current fluctuation range of the output terminal T₂ is large. Therefore, when the load connected to the second power supply 220 increases and the load power of the output terminal T₂ increases, the controller 140 controls the auxiliary switch S_{A} so that the on duty of the auxiliary switch increases because the current flowing through the output terminal T₂ increases. However, when the load connected to the second power supply 220 decreases and the load power of the output terminal T₂ decreases, the controller 140 controls the auxiliary switch S_{A} so that the on duty of the auxiliary switch S_{A} decreases.

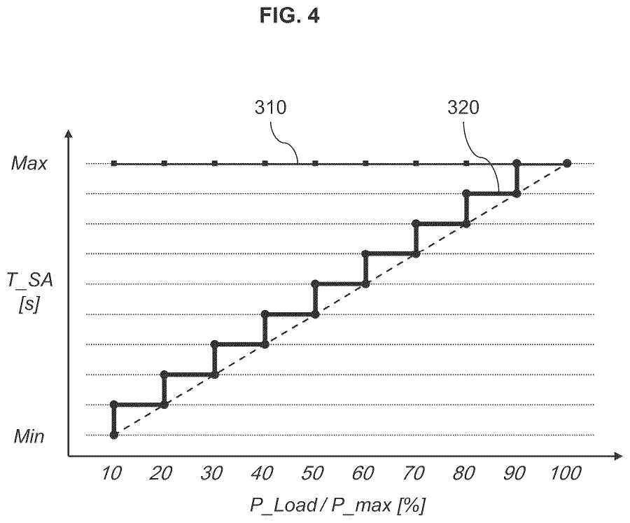

FIG. 4 is a graph showing an embodiment of the on duty of the auxiliary switch S_{A} according to the load power fluctuation.

In the load power based DC-DC converter 1 according to an embodiment of the present disclosure, the controller 140 includes a load power based lookup table, which is a lookup table in which the on duty of the auxiliary switch S_{A} is stored for each predetermined margin of the load power. Specifically, the controller 140 may include a storage unit (not illustrated) made of a memory element, and the load power based lookup table may be stored in the storage unit (not illustrated). In the load power based lookup table, the load power of the load power based DC-DC converter 1 may be divided for each predetermined margin, and the on duty of the auxiliary switch may be correspondingly stored for each predetermined margin.

The storage unit (not illustrated) may store an algorithm or program for controlling the main switch S_{M} and the auxiliary switch S_{A} of the present disclosure, and may be a storage medium formed of a nonvolatile memory or a volatile memory.

Referring to FIG. 4, an x-axis represents the load power P_{load}/Pₘₐₓ compared to the maximum capacity, which is a value converted into a percentage by dividing the load power P_{load} by the maximum capacity Pₘₐₓ of the load power based DC-DC converter 1, and a y-axis represents the on duty time value of the auxiliary switch S_{A}. FIG. 4 illustrates a graph 310 of the on duty of the auxiliary switch S_{A} in the case of the maximum load power, and illustrates a graph 320 of the on duty of the auxiliary switch S_{A} according to an embodiment of the present disclosure. That is, the graph 320 of the on duty of the auxiliary switch S_{A} according to an embodiment of the present disclosure of FIG. 4 illustrates the load power based lookup table as a graph.

The controller 140 controls the auxiliary switch with the on duty of the auxiliary switch stored in the load power based lookup table as the load power varies. Specifically, as illustrated in the x-axis of FIG. 4, the load power is divided by a predetermined margin, and each margin has a value of the on duty of the auxiliary switch S_{A}. For example, the on duty of the auxiliary switch S_{A} has a constant value in a margin where the load power P_{load}/Pₘₐₓ is 10% or more and less than 20% of the maximum capacity, and the on duty of the auxiliary switch S_{A} also has a constant value in a margin where the load power P_{load}/Pₘₐₓ is 20% or more and less than 30% of the maximum capacity, but may have a different value from the on duty of the auxiliary switch S_{A} in a margin where the load power of the load power based DC-DC converter 1 is 10% or more and less than 20%. Therefore, when the controller 140 determines that the load power of the load power based DC-DC converter 1 has a value within a predetermined margin by referring to the load power based lookup table, the controller controls the auxiliary switch S_{A} so that the on duty of the auxiliary switch S_{A} is controlled to the on duty of the auxiliary switch S_{A} according to the corresponding load power margin of the load power based lookup table.

However, as illustrated in FIG. 4, the on duty of the auxiliary switch S_{A} stored in the load power based lookup table does not exceed the on duty of the auxiliary switch S_{A} in the case of maximum load power. That is, the graph 320 of the on duty of the auxiliary switch S_{A} according to an embodiment of the present disclosure cannot have a value exceeding the graph 310 of the on duty of the auxiliary switch S_{A} in the case of maximum load power.

However, the size between the margin and the margin of the load power P_{load}/Pₘₐₓ compared to the maximum capacity illustrated in FIG. 4 and the size of the on duty of the auxiliary switch S_{A} may have, for example, different values from those illustrated in FIG. 4.

That is, since the on duty of the auxiliary switch S_{A} is constant according to the margin of the load power, there is no need to calculate the on duty of the auxiliary switch S_{A} in real time according to the change of the load power in real time, so the burden of calculating the on duty of the auxiliary switch S_{A} may decrease, so the responsiveness of the control may increase, and the complexity of the control may also decrease.

The low power based DC-DC converter 1 according to an embodiment of the present disclosure may further include a driver 150 that drives the main switch S_{M} and the auxiliary switch S_{A} according to the control of the controller 140. Specifically, the driver 150 may apply a PWM signal to the gate of the main switch S_{M} and the gate of the auxiliary switch S_{A} according to the control of the controller 140.

According to the load power based DC-DC converter 1 according to the present disclosure as described above, unlike the conventional method of controlling the duty of the auxiliary switch S_{A} based on the maximum load power, the load power, which is the current from the output terminal T₂ output from the DC-DC converter, is calculated and the duty of the auxiliary switch S_{A} is controlled accordingly, so the freewheeling margin may decrease and the energy loss may also be reduced accordingly, thereby increasing the power efficiency of the load power based DC-DC converter according to an embodiment of the present disclosure.

In addition, since the margin is set for the converter load power and the duty of the auxiliary switch S_{A} is controlled stepwise according to the duty of the auxiliary switch S_{A} determined for each preset margin, it is possible to increase the responsiveness of the control and decrease the complexity of the control.

According to the load power based DC-DC converter according to the present disclosure as described above, unlike the conventional method of controlling the duty of the auxiliary switch based on the maximum load power, the load power, which is the power output through the output terminal output from the DC-DC converter, is calculated and the duty of the auxiliary switch is controlled accordingly, so the unnecessary freewheeling margin may decrease and the energy loss may also be reduced accordingly, thereby increasing the power efficiency of the load power based DC-DC converter according to the present disclosure.

In addition, since the margin is set for the converter load power and the duty of the auxiliary switch is controlled according to the duty of the auxiliary switch determined in advance for each margin, it is possible to increase the responsiveness of the control and decrease the complexity of the control.

The present disclosure should not be construed to being limited to the embodiment described above. The present disclosure may be applied to various fields and may be variously modified by those skilled in the art without departing from the scope of the present disclosure claimed in the claims. Therefore, it is obvious to those skilled in the art that these alterations and modifications fall in the scope of the present disclosure.

What is claimed is:

1. A load power based DC-DC converter, comprising:
an input circuit connected to an input terminal and including a main switch;
a resonant circuit connected to the input circuit and including an auxiliary switch configured to perform zero-voltage switching on the main switch;
an output circuit connected to the resonant circuit and configured to output a voltage to an output terminal; and
a controller configured to control the main switch and the auxiliary switch,
the controller further configured to:
calculate a load power, which is power output through the output terminal, and
control the auxiliary switch so that on duty of the auxiliary switch increases or decreases based on the load power.

2. The load power based DC-DC converter of claim 1, wherein the resonant circuit includes:
a resonant capacitor connected in parallel with the main switch;
a resonant inductor comprising a first terminal connected to the resonant capacitor; and
an auxiliary diode comprising an anode connected to a second terminal of the resonant inductor and a cathode connected to the output circuit, and
a first terminal of the auxiliary switch connected to the second terminal of the resonant inductor, and a second terminal of the auxiliary switch connected to the other terminal of the resonant capacitor.

3. The load power based DC-DC converter of claim 2, wherein the controller is configured to:
control the auxiliary switch so that the on duty of the auxiliary switch increases in response to the load power increasing, and
control the auxiliary switch so that the on duty of the auxiliary switch decreases in response to the load power decreasing.

4. The load power based DC-DC converter of claim 3, wherein the controller includes a load power based lookup table which is a lookup table in which the on duty of the auxiliary switch is stored for each predetermined margin of the load power, and
wherein the controller is configured to control the auxiliary switch with the on duty of the auxiliary switch stored in the load-based lookup table in response to the load power varying.

5. The load power based DC-DC converter of claim 2, wherein the output circuit further includes:
a main diode comprising an anode connected to the second terminal of the resonant inductor and a cathode connected to the cathode of the auxiliary diode; and
a DC capacitor comprising a first terminal connected to the cathode of the main diode and a second terminal connected to a negative electrode of the output terminal.

6. The load power based DC-DC converter of claim 1, wherein, in response to the load power being P_{Load}, a voltage of the output terminal being Vₒᵤₜ, and a current of the output terminal being Iₒᵤₜ, the load power is configured to be calculated according to the following Equation 1:
$${P}_{Load} = {V}_{out} \cdot {I}_{out} . \qquad Equation 1$$

7. The load power based DC-DC converter of claim 1, wherein the input circuit includes a first inductor comprising a first terminal connected to a positive electrode of the input terminal and a second terminal connected to a first terminal of the main switch, and
wherein a second terminal of the main switch is connected to a negative electrode of the input terminal.
